(19) United States
(12) Patent Application Publication
(10) Pub. No.: US 2004/0232219 A1
(43) Pub. Date: Nov. 25, 2004

(54) Medical treatment and prescription administration verification method

(76) Inventor: Timothy Charles Fowler, Raleigh, NC (US)

Correspondence Address: JINAN GLASGOW, P O BOX 28539, RALEIGH, NC, 276118539

(21) Appl. No.: 10/441,767

(22) Filed: May 20, 2003

(51) Int. Cl. G06K 5/00

(52) U.S. Cl. 235/380

(57) ABSTRACT

A method for using a patient identification card to avoid prescription and health care treatment errors, the method including a system having a patient identification card for storing, adding, deleting and modifying patient medical information, the card being a smart card having a microprocessor thereon, and an electronic patient identification access device for accessing the patient medical information, wherein the patient identification card is compact, portable, and connectable to a patient so that it is accessed by the electronic patient identification access device in proximity to the patient, the system providing an authorization for at least one user to access the information on the patient identification card, wherein the authorization is provided by patient and included on the card and confirmable by the electronic patient identification access device.

### BACKGROUND OF THE INVENTION

(1) Field of the Invention

The present invention relates generally to medical and pharmaceutical administration and, more particularly, to a method for patient identification to avoid prescription and health care treatment errors.

(2) Description of the Prior Art

Typically, prior art devices have been used to identify a patient for medical treatment and prescription administration.

Prior art devices and methods commonly employ computers, patient identification bracelets, and electronic identification methods for identifying patients and/or tracking patient medical procedures and medications. However, these devices and methods fail to provide consistent electronic information that is accessible by all medical professionals associated with providing patient care, diagnostics, testing, prescription and medication administration. In some cases, the patient identification is entirely or partially manual, which introduces the likelihood of error from transcription of patient identification and/or corresponding medical treatment, procedures, prescriptions, testing, and diagnosis. Also, the accessibility to patient information and identity is generally limited by the location of the computers and computer networks, which are not generally located with the patient and/or are not portable, as well as appropriate security means for ensuring that patient information is not accessed by unauthorized individuals and/or entities, in particular under the recent Health Insurance Portability and Accountability Act of 1996 (HIPAA) regulations that were intended to provide protection to a patient's medical records, and which take effect in the United States on Apr. 14, 2003. Furthermore, with reduced access to medical records to ensure patient privacy rights, it has become increasingly difficult to provide adequate, consistently updated information to the appropriate health care providers, which may increase the likelihood of errors, some of which may be harmful to the patient, or even fatal.

Examples of prior devices and/or methods in the relevant art include the following issued US patents:

U.S. Pat. No. 6,464,136 issued Oct. 15, 2002 to Walsh for Record and verification method, apparatus and system. A system, apparatus and method for verification of the identity of a patient undergoing treatment administered by a medical treatment practitioner with identifying elements for the patient located in the treatment room.

U.S. Pat. No. 5,832,488 issued Nov. 3, 1998 to Eberhardt for Computing system & method for storing medical histories using a smartcard to store data. A computer system & method for programming it for storage of individual medical histories on a storage device, for adding new data, and for communicating it with other computers.

U.S. Pat. No. 5,651,775 issued Jul. 29, 1997 to Walker et al. for Medication delivery & monitoring system & methods. A medication delivery and monitoring system & methods for safe deliver of drugs to a patient, monitored in real-time delivery, with crucial events being recorded in real-time, on-line information, and detail for an audit trail.

U.S. Pat. No. 4,476,381 issued Oct. 9, 1984 to Rubin for Patient treatment method. A patient treatment method and system facilitating automated treatment of a patient, including establishing a direct linkage between the patient, tests performed on the patient, specimens taken, and medication & services administered to the patient; it includes a patient identification method having a wrist bracelet, and a mediation verification method & device.

U.S. Pat. No. 6,488,205 issued Dec. 3, 2002 to Jacobson for System and method for processing data on an information card. A system and method for extracting and processing data contained on an information card, particularly a healthcare plan identification card, for use in decision-making about the individual associated with the card.

U.S. Pat. No. 6,471,089 issued Oct. 29, 2002 to Liff, et al. for Method for controlling a drug dispensing system. An automated drug dispensing system and method for dispensing pre-packaged pharmaceuticals for filling patient prescriptions.

U.S. Pat. No. 6,421,650 issued Jul. 16, 2002 to Goetz et al. for Medication monitoring apparatus and system. A medication management system including a patient and medical history component, a physician component, and a pharmacist component, wherein information is provided on a database for selective downloading to assist with administration of the medication.

U.S. Pat. No. 6,439,7190 issued May 28, 2002 to Goetz et al. for Veterinary medication monitoring apparatus and system. A veterinary medication management system including a database with an animal patient component, a veterinarian component, and vet support component.

U.S. Pat. No. 6,352,200 issued Mar. 5, 2002 to Schoonen et al. for Medicament distribution system & automatic dispenser. A pharmacy system for prescribing & delivering medicaments to a patient including at least one input unit by a doctor that generates a corresponding prescription signal that is used with a patient's identity for automatic prescription distribution.

U.S. Pat. No. 6,330,491 issued Dec. 11, 2001 to Lion for Integrated system & method of vending prescription medications using a network of remotely distributed, automated dispensing units. A network of interactive, self-service medication dispensing kiosks.

U.S. Pat. No. 6,321,203 issued Nov. 20, 2001 to Kameda for Medical care schedule & record aiding system & method. A medical care system including units with data storage, identification data and medical care information relevant to a patient.

U.S. Pat. No. 6,272,481 issued Aug. 7, 2001 to Lawrence et al. for Hospital-based integrated medical computer system for processing medical & patient information using specialized functional modules. A hospital-based integrated system for processing medical & patient info, including a medical processor, data banks, and modules; physician & patient access points provided.

U.S. Pat. No. 6,259,355 issued Jul. 10, 2001 to Chaco et al. for Patient care & communication system. A patient care & communication system using a central processing system & plurality of remote stations connected electronically, including visual, data & telephone communications, a patient locator system having an infrared receiver for transmissions from a transmitter worn by a staff member or patient, providing identity information.

U.S. Pat. No. 6,139,495 issued Oct. 31, 2000 to De La Huerga for Medical accident avoidance method & system. A system and method for identifying medical events, which have not yet been prescribed for performance on a patient; the system can perform a check of diagnosis & prescription.

U.S. Pat. No. 6,026,363 issued Feb. 15, 2000 to Shepard for Medical history documentation system and method. A medical history documentation system and method for recording information relating to a patient's medical condition, physical exam, diagnosis & treatment plan.

U.S. Pat. No. 6,021,392 issued Feb. 1, 2000 to Lester, et al. for System and method for drug management. A system and method for drug management wherein a drug distribution center operates a computer software drug inventory management program in electronic communication with a health care provider computer software program for drug and health care supply distribution to patients.

U.S. Pat. No. 6,012,035 issued Jan. 4, 2000 to Freeman, Jr., et al. for System and method for supporting delivery of health care. A communication network linking all various entities of a health care provision agency cooperative, including pharmacies, laboratories, primary and secondary service providers and the patient; a coordinating interface system maintains data storage of info and manages intercommunications.

U.S. Pat. No. 5,923,018 issued Jul. 13, 1999 to Kameda, et al. for Medical care schedule & record aiding system.

U.S. Pat. No. 5,913,197 issued Jun. 15, 1999 to Kameda for Medical care schedule & record aiding system & method.

U.S. Pat. No. 5,855,609 issued Jan. 5, 1999 to Knapp for Medical information trasnponder implant & tracking system.

U.S. Pat. No. 5,845,255 issued Dec. 1, 1998 to Mayaud for Prescription management system.

U.S. Pat. No. 5,832,449 issued Nov. 3, 1998 to Cunningham for Method & system for dispensing, tracking & managing pharmaceutical trial products.

U.S. Pat. No. 5,822,544 issued Oct. 13, 1998 to Chaco, et al. for Patient care & communication system.

U.S. Pat. No. 5,923,018 issued Oct. 20, 1998 to Ross, Jr., et al. for Medical records, documentation, tracking & order entry system.

U.S. Pat. No. 5,748,907 issued May 5, 1998 to Crane for Medical facility & business: automatic interactive dynamic real-time management. System includes a microprocessor adapted to sense the automatic interaction of real-time inputs relating to the method of controlling the position, flow of patients, employees, invoicing, scheduling, financial costs, and time, space, and tasks automatically of a medical clinic.

U.S. Pat. No. 5,689,229 issued Nov. 18, 1997 to Chaco, et al. for Patient care & communication system.

U.S. Pat. No. 5,594,786 issued Jan. 14, 1997 to Chaco, et al. for Patient care & communication system.

U.S. Pat. No. 5,261,702 issued Nov. 16, 1993 to Mayfield for Daily medication management system.

Thus, there remains a need for a method for patient identification for medical treatment and prescription administration having patient identification means that are connected and/or proximal to the patient and automatically confirmable by electronic confirmation means for providing appropriate security for access to the patient's information by authorized health care providers.

### SUMMARY OF THE INVENTION

The present invention is directed to a method for patient identification for medical treatment and prescription administration having patient identification means that are connected and/or proximal to the patient and automatically confirmable by electronic confirmation means for providing appropriate security for access to the patient's information by authorized health care providers.

Accordingly, one aspect of the present invention is to provide a method for using a patient identification card to avoid prescription and health care treatment errors, the method including the steps of:

providing a system including a patient identification card for storing, adding, deleting and modifying patient medical information, the card being a smart card having a microprocessor thereon, and an electronic patient identification access device for accessing the patient medical information, wherein the patient identification card is compact, portable, and connectable to a patient so that it is accessed by the electronic patient identification access device in proximity to the patient;

providing an authorization for at least one user to access the information on the patient identification card, wherein the authorization is provided by patient and included on the card and confirmable by the electronic patient identification access device.

These and other aspects of the present invention will become apparent to those skilled in the art after a reading of the following description of the preferred embodiment when considered with the drawings.

### BRIEF DESCRIPTION OF THE DRAWINGS

FIG. 1 is a flow chart showing the steps of a method for using the system according to the present invention.

### DETAILED DESCRIPTION OF THE PREFERRED EMBODIMENTS

In the following description, like reference characters designate like or corresponding parts throughout the several views. Also in the following description, it is to be understood that such terms as “forward,” “rearward,” “front,” “back,” “right,” “left,” “upwardly,” “downwardly,” and the like are words of convenience and are not to be construed as limiting terms. A few design examples are described herein as best mode embodiments known at the time of the present invention, not necessarily optimized, but illustrative of what is included in a method and system according to the present invention, wherein the patient identification device includes an electronic data storage device that is compact and portable and attachable to a patient.

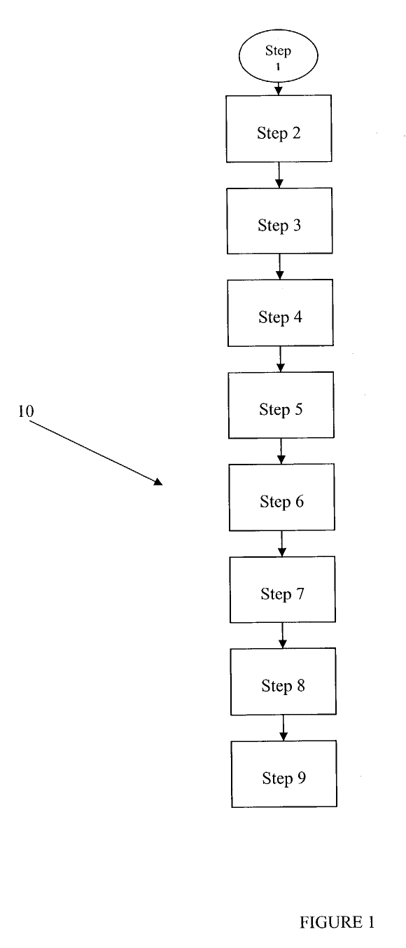

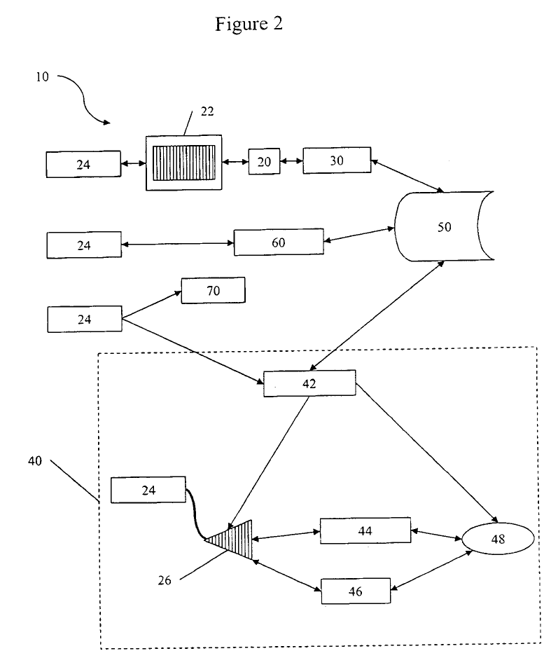

Referring now to the drawings in general, the illustrations are for the purpose of describing a preferred embodiment of the invention and are not intended to limit the invention thereto. As best seen in FIG. 1, a flow chart illustrates a method for using a patient identification card to avoid prescription and health care treatment errors, the method using a system, generally referenced 10, the system including a patient identification and/or confirmation means, further including an electronic patient identification device for storing patient information that is compact, portable, and connectable to a patient. STEP 1: A card is provided to a patient, such as a smart card, that contains the patient-specific information. The information includes but is not limited to past history, drug allergies, past illnesses, medications, age, weight, height, etc. The card is preferably credit card sized. The card is issued/updated at a physician's office or hospital via a read/write interface on any type of computer. Once the updated information is entered, the computer is capable of cross-referencing the information with a database, prior to writing the information on to the card. This ensures that the new medication would not conflict with an existing medication. This would be extremely helpful due to the fact that most people see more than one physician and may be taking medications prescribed by multiple doctors.

STEP 2: The card is presented to the pharmacist at the time the medications are picked up. Prior to release of the medication the card would be scanned. Again the information would be cross-referenced with the database to prevent errors. Any minor issues are preferably discussed with the patient and written warning and/or other information given. Major issues preferably would require a physician's release or code to dispense. Also, preferably, a digital imprint of the pharmacy's ID number, time, and date is included.

STEP 3: In a hospital setting the card is presented at the time of arrival. All of the patient's information would be transferred to a “Mini-card”. The mini-card would resemble the small “Valuable customer” cards, a lot of time worn on key rings, used at the grocery store.

STEP 4: The mini-cards would be affixed to the patient's wrist bracelet much like a charm on a charm bracelet. The wristband would still contain patient name, number, etc. Future models may incorporate the smart card chip into the “Tag end” of the bracelet, past the clasp. The card would need to be somewhat mobile to facilitate the card being scanned.

STEP 5: The doctors and nurses would carry tablet P/C's and PDA's. The doctor could update the information on any visit. The medications, procedures, etc. would be updated instantly both on the card and at the nurse's station. The nurse's station would update via a wireless network.

STEP 6: The nurse's station would act as a hub for the information of the patient's on that floor. The nurse's station computer would notify the attending nurses PDA when medications or procedures were required. The nurse's station would be notified via the wireless network when the attending nurse had administered the doctor's orders. If the patient did not receive the proper attention in the prescribed time an alarm would sound requiring immediate attention. This notification method would be extremely helpful since a medication, administered outside of the specified time, is a drug error.

STEP 7: Prior to giving the patient the prescribed medication the nurse would have to scan the patient's card. This would be to verify the drug, the dosage, and the patient's identity. It would also leave a digital imprint of the time and nurse's ID number.

STEP 8: Prior to any prescribed procedures being performed the card would have to be scanned. This would prior to test, lab work, physical therapy, surgery, etc. Basically prior to anything being done on a patient's behalf in a hospital.

STEP 9: In the case of an emergency the cards would have a “One shot” override, before it would have to be reissued by a physician. This would allow the EMT worker or a physician access to the patient's information without the required PIN code or identity information. An EMT worker could be relaying patient information while in route to hospital. The hospital ER could then reduce the “Reaction” time significantly.

Preferably, the electronic patient identification device includes a smart card, which is capable of storing at least about 8 megabytes to about 32 megabytes of data relating to a patient's identity, medical records, medical history, as well as current medical procedures, testing, diagnostics, and prescription medications that a patient is undergoing or to be undergoing under the care of at least individual medical practitioner or entity including a multiplicity of medical practitioners. Alternatively, a bar code or a magnetic swipe strip may be used to provide more limited patient data. Also preferably, the patient's card includes a microprocessor, so that the patient's data can be updated as additional medical information such as test results, diagnosis, procedures, and the like are performed and medications are prescribed and/or administered. The electronic patient identification device is preferably a mini card, which can be attached to the patient's body or clothing, such as with a clip, pin, bracelet, necklace, earring, ring, and the like.

In particular, it is advantageous to employ the electronic patient identification device according to the present invention for use within an entity such as a hospital or similar institutional or with a physician's office having a multiplicity of practitioners therein for ensuring that the patient's information is consistently and accurately communicated and available to authorized practitioners, thereby avoiding miscommunication or misunderstanding that can cause errors with respect to the patient's diagnosis, treatment, and medication prescription and/or administration. Medical practitioners include, by way of example and not limitation, physicians, physician assistants, nurses, technicians, surgeons, medical specialists, pharmacists, and hospital administrative staff. Medical practitioners preferably have different, respective levels of access to the patient data that is stored on the electronic patient identification device.

Preferably, each patient is provided a unique identification (ID) card that is provided in proximity to the patient location and/or is connected or attached to the patient. Also preferably, to further ensure that the patient's ID card belongs to that patient, security means are provided, including, by way of example and not limitation, at least one biometric identifier such as a fingerprint, DNA, or other unique identifier, such as a personal identification code, which may be numbers, letters, symbols, and combinations thereof. The at least one unique identifier information is included, programmed or otherwise embedded into a computer chip or other electronic readable or scannable form. This information may be encrypted for further security and patient protection. The unique identifier information is preferably attached to the patient in the ID card or bracelet. Replacement cards may be provided as necessary, but preferably the card is provided in a form that is wear- and water-resistant so that the patient does not need to remove it and it can be connected to or worn by the patient at all times.

The at least one medical practitioner can confirm the at least one unique patient identifier information on the card using a card reader. The card readers may be proximity-based and/or portable. Preferably the card readers are portable so that each of the at least one medical practitioner can confirm the patient identification as provided by the ID card, as well as to access predetermined data stored on the card, such as medical diagnoses, treatments, prescriptions, medical history, and the like, based upon the authorization level provided to each of the at least one medical practitioners. Preferably, multiple authorization levels are provided according to the HIPAA or other relevant regulations, laws, or rules, e.g., physicians have greater access to more information as compared with technicians who are performing tests. Each level of access and/or each of the at least one medical practitioners is provided by a PIN code or other security means, which may also be biometric or electronic, such as scanning a bar code on a badge or other identification device. In the case of portable card readers, the physicians, nurses, and other practitioners may carry them as they visit patients at different locations. Examples of readers may include devices specifically constructed and configured for reading these cards or may be multi-use devices such as personal digital assistants (PDAs) or tablet computers.

By way of example, one application for the present invention relates to a patient identification system for health care applications wherein the patient requires a treatment, such as an organ donated for transplant where the at least one patient identifier is attached to or connected with the patient and a corresponding identifier is included on a container for the organ with a code that must be confirmed with the patient's identifier in order to match the organ with the patient. Another application includes at least one reader at a pharmacy wherein the pharmacist matches prescriptions that are being filled with each of the patients to receive them by entering information that can be electronically matched or confirmed to correspond to the patient having the unique patient identifier; this provides for a double-checking of prescriptions: one at filling and one at administration, with a potential for an additional checking at prescription pick-up by the patient where the pharmacy is off-site from a hospital or other treatment facility. Yet another application of the system according to the present invention includes most types of medical procedure sites, which would have a card reader for verifying the identity of the patient by electronically checking the information on the unique patient identification card, including patient identification and procedure intended to be performed, which prevents incorrect procedures or inappropriate procedures from being performed based on the patient's identification, condition, diagnosis, medical history, and similar features. Also, drug cross-references and diagnosis double-checking can be performed automatically against a database of relevant history and/or medical information and/or with authorized users with access thereto. Examples of procedures, which are provided in order to clearly set forth applications of the present invention but which are not intended to limit the invention entirely thereto include, transfusions, testing and/or diagnostic procedures, surgery sites, and prescription administration locations, which may be the patient's room in a facility such as a hospital.

As set forth hereinabove, the present invention provides for a number of users of the system to have varied access levels to the patient's information, such access varying by user identity, such as by the identity of an individual and/or by the identity of the classification of types of users, e.g., doctors, pharmacists, technicians, nurses, etc., and included on the unique patient identification card, such access being provided consistent with HIPAA regulations and with the patient's approval, usually to be provided and/or programmed onto the card in advance by the patient, and which can be modified, including new entries for authorization for access as well as modification of level of access and denial of access by the patient for the at least one medical practitioner or other medical administrative person. Preferably, the access would be provided on the card so that using a card reader and security confirmation means, such as biometric and/or PIN identification, varied levels of access include patient access, location-specific user access (i.e., certain users may access the information on the card only at predetermined locations, to ensure increased security for the patient's information so that it is accessed by authorized users at corresponding appropriate access locations, where the card is read on a proximity-based device and/or a portable device that is associated with a location, e.g., a hospital or doctor's office), professional access only, restricted access, insurance administration access, non-physician access, and the like, and combinations thereof. By way of example, patients can restrict access to this information, for example, to permit limited access for an insurance company and/or administrator to process an insurance claim for a medical procedure or treatment while preventing the insurance company and/or administrator from having access to the results of the medical procedure, treatment and/or testing. This type of application of the system according to the present invention can be used by medical practitioner and facilities to ensure, document, and prove that they have taken all reasonable measures to ensure the security and privacy of the patient's information with respect to the HIPAA regulations.

Additionally, the access to the card may be updated and/or updatable, in particular at predetermined intervals that correspond to those authorized by the patient and/or that are pre-programmed into a database including information that governs access to the card and the information included thereon. A time-out feature may be provided such that a business may be established to gain revenues for managing the system of authorized users to the patient's information without requiring the system manager to have any access to the patient information; rather, the system manager provides for authorization for the system users, particularly where the authorization is time-based, i.e., provided for a predetermined, limited time until the authorization expires or is terminated, e.g., when a patient discontinues seeing a specialist for a particular treatment or changes physicians, and the like. The patient can then indicate to the system manager that authorization is changed via an electronic submission and/or confirmation that may occur via a website or secure network with a log-in that provides at least the same level of security that is provided for accessing the information on the unique identification card for a patient. The system manager then provides the authorization access information, log-in, and the like to the user(s) who may be required to pay to have access to the system, and/or who subscribe to the automated system in order to ensure compliance with HIPAA regulations, as set forth in the foregoing.

Therefore, a method for using the system set forth hereinabove includes using a patient identification card to avoid prescription and health care treatment errors, the method including the steps of:

providing a system including a patient identification card for storing, adding, deleting and modifying patient medical information, the card being a smart card having a microprocessor thereon, and an electronic patient identification access device for accessing the patient medical information, wherein the patient identification card is compact, portable, and connectable to a patient so that it is accessed by the electronic patient identification access device in proximity to the patient;

providing an authorization for at least one user to access the information on the patient identification card, wherein the authorization is provided by patient and included on the card and confirmable by the electronic patient identification access device.

Furthermore, a method for using the system set forth hereinabove that follows a “lock-out/tag-out” type procedure as used in electrical systems testing for construction projects. In such a method, the system above is used to verify prescription and/or procedures within hospital. Each of the at least one practitioners must access the card and the information thereon by using a corresponding identifier for authorized access based upon patient authorization. Such access is noted and documented on the card, like a log of access, so that the patient may review and document who has had access to the information. This method provides for a simple procedure without too many steps, as well as a cross-reference to those with access to only that corresponding information that is appropriate for the authorization level for that user. Also, cross-reference to related treatment can occur automatically based upon a database when the card is scanned by the card reader and connected to a system that provides for information on the patient's previous treatments, as well as other medications, other procedures and/or conditions relating to the patient to ensure that proper care is taken to avoid medical and administrative errors. By way of illustration of a hypothetical case based upon a real-life situation, consider the following example:

A patient hospitalized with what was thought to be a mild heart attack. The doctor ordered, both verbally and on the chart, a scan of the heart without the “Stress” portion of the test. (i.e. the stress portion of the stress in performed on a treadmill with an ever increasing incline). The doctor was worried that the stress portion of the test would induce a full-blown heart attack. Three different people at different tried to perform the full test. Without the nurse's assistant who heard the orders the situation could have been tragic.

Certain modifications and improvements will occur to those skilled in the art upon a reading of the foregoing description. By way of example, an access override may be provided in advance by the patient for emergency medical treatment and/or in the case that the patient is unconscious or otherwise not capable of providing authorization for the medical practitioner(s) in order to have life-saving treatment. Such advance authorization may be confirmed or confirmable at a later time by the patient, and may be so indicated on the log. Also, doctors could send revised orders or prescriptions to the hospital of pharmacy via encrypted e-mail or over the phone with voice recognition software. All modifications and improvements have been deleted herein for the sake of conciseness and readability but are properly within the scope of the following claims.

1. A method for using a patient identification card to avoid prescription and health care treatment errors, the method comprising the steps of
providing a system including a patient identification card for storing, adding, deleting and modifying patient medical information, the card being a smart card having a microprocessor thereon, and an electronic patient identification access device for accessing the patient medical information, wherein the patient identification card is compact, portable, and connectable to a patient so that it is accessed by the electronic patient identification access device in proximity to the patient;
providing an authorization for at least one user to access the information on the patient identification card, wherein the authorization is provided by patient and included on the card and confirmable by the electronic patient identification access device.

2. The method according to claim 1, wherein the authorization is provided for varied levels of access to the information based upon the identity of the at least one medical practitioner.

3. The method according to claim 1, wherein the patient identification card is provided for a multiplicity of patients, with each patient having a unique identifier thereon that corresponds to only that individual.

4. The method according to claim 1, further including the step of providing a unique patient identifier for each card, wherein the patient identifier provides for definite identification of the corresponding patient.

5. The method according to claim 4, wherein the unique patient identifier is a biometric identifier, wherein the patient identifier provides for definite identification of the corresponding patient.

6. The method according to claim 4, wherein the unique patient identifier is a PIN.

7. The method according to claim 1, wherein the card is attachable to a bracelet.

8. The method according to claim 1, wherein the authorization includes a PIN code.

9. The method according to claim 1, wherein the electronic patient identification access device is proximity-based.

10. The method according to claim 1, wherein the electronic patient identification access device is portable.

11. The method according to claim 1, wherein the electronic patient identification access device is a tablet computer.

12. The method according to claim 1, wherein the at least one user includes at least one medical practitioner.

13. The method according to claim 1, further including the step of the at least one authorized user definitively confirming the patient identity at a medical procedure site.

14. The method according to claim 1, further including the step of the at least one authorized user definitively confirming the patient identity prior to performing a medical procedure.

15. The method according to claim 14, wherein the medical procedure is selected from the group consisting of a transfusion, a test, a surgery, a prescription administration, a delivery, an organ transplant, and combinations thereof.

16. The method according to claim 1, further including the step of the patient updating access authorization for the at least one authorized user.

17. The method according to claim 1, further including the step of the at least one user applying for authorization.

18. The method according to claim 17, further including the step of the patient providing authorization to the at least one user who has applied for access.

19. The method according to claim 18, wherein a system manager acts as an intermediary for receiving the authorization from the patient and providing authorization to the at least one user.

20. The method according to claim 18, further including the step ofupdating the authorization for users at predetermined intervals.
